(19) United States
(12) Patent Application Publication
(10) Pub. No.: US 2005/0245413 A1
(43) Pub. Date: Nov. 3, 2005

(54) Dishwashing machine

(76) Inventors: Reinhold Baltes, Roschberg (DE); Konrad Petry, Mandelbachtal 3 (DE)

Correspondence Address: WHIRLPOOL PATENTS COMPANY - MD 0750, 500 RENAISSANCE DRIVE - SUITE 102, ST. JOSEPH, MI, 49085, US

(21) Appl. No.: 11/077,022

(22) Filed: Mar. 10, 2005

(30) Foreign Application Priority Data
Mar. 10, 2004 (EP) 04005683.0

(51) Int. Cl. C11D 1/00

(52) U.S. Cl. 510/224

(57) ABSTRACT

A dishwashing machine having a washing chamber, a wash pump arranged to be driven by an electric motor for pumping up wash water from a wash water tank in the washing chamber and a control unit for controlling the washing cycle of the machine. The control unit is capable of detecting at least one working parameter of the electric motor of the pump, such parameter being linked to one or more parameters of the washing cycle and being used for controlling such cycle.

### BACKGROUND OF THE INVENTION

1. Field of the Invention

The present invention relates to a dishwashing machine having a washing chamber, a wash pump arranged to be driven by an electric motor for pumping up wash water from a wash water tank in the washing chamber and a control unit for controlling the washing cycle of the machine.

2. Description of the Related Art

It is recognized that the control unit of a dishwashing machine, which can be electromechanical or electronic, must drive the components of the machine (valves, discharge pump, wash pump, heating element, etc.) at the right moment and for the right time. Moreover, the control unit receives some input signals from sensors, for instance water level sensors in the wash water tank, in order to assure a correct working cycle. It is also recognized that the use of such sensors does increase the overall cost of the dishwashing machine. Furthermore, the use of such sensors, particularly of water level sensors, does not always prevent the machine from performing poorly when there is too much foam in the wash water tank (pulsating flow of wash water upstream the spray arms, with subsequent noise and possible damages to the pump motor).

Accordingly, it would be advantageous to provide a dishwashing machine such as is described in the present invention in order to eradicate the above-mentioned problems.

### SUMMARY OF THE INVENTION

The present invention relates to a dishwashing machine having a washing chamber, a wash pump arranged to be driven by an electric motor for pumping up wash water from a wash water tank in the washing chamber and a control unit for controlling the washing cycle of the machine.

According to the invention, one may use a synchronous motor as motor for the wash pump. By controlling one or more electric parameters of the motor, for instance the current absorbed by the motor or its actual power, it is possible to correlate such feature with the working condition of the machine, particularly with the water level or with the amount of foam in the tank. Therefore, according to the present invention, it is possible to avoid the use of a water level sensor in the tank with obvious advantages in terms of cost reduction. Moreover in a dishwashing machine according to the present invention it is possible to check in a more reliable way the stability of the pump working condition, i.e. the presence of pulsating phenomena due to the presence of foam.

### BRIEF DESCRIPTION OF THE DRAWINGS

The features and advantages of the present invention will be more fully appreciated and the invention itself will be better understood when the following detailed description is read in conjunction with the accompanying drawings, in which:

FIG. 1 is a schematic view of a dishwashing machine according to the invention;

FIG. 2 is a power and current consumption diagram with different volumes of intake water;

FIG. 3 is a power and current consumption diagram with different volumes of intake water;

FIG. 4 is a power and current consumption diagram with different volumes of intake water;

FIG. 5 is a power and current consumption diagram with different volumes of intake water;

FIG. 6 is a power and current consumption diagram with different volumes of intake water;

FIG. 7 is a power and current consumption diagram with different volumes of intake water;

FIG. 8 is a power and current consumption diagram with different volumes of intake water;

FIG. 9 is a power and current consumption diagram with different volumes of intake water;

FIG. 10 is a power and current consumption diagram with different volumes of intake water;

FIG. 11 is a power and current consumption diagram with different volumes of intake water;

FIG. 12 is a power and current consumption diagram with different volumes of intake water;

FIG. 13 is a power and current consumption diagram with two different volumes of intake water and synchronous motor blocked;

FIG. 14 is a power and current consumption diagram with two different volumes of intake water and synchronous motor blocked;

FIG. 15 is a power and current consumption diagram with a constant intake volume of water (5.0 liters) and different quantities of rinsing agent;

FIG. 16 is a power and current consumption diagram with a constant intake volume of water (5.0 liters) and different quantities of rinsing agent;

FIG. 17 is a power and current consumption diagram with a constant intake volume of water (5.0 liters) and different quantities of rinsing agent;

FIG. 18 is a power and current consumption diagram with a constant intake volume of water (5.0 liters) and different quantities of rinsing agent;

FIG. 19 is a power and current consumption diagram when the water volume is reduced from 5 liters to 2.5 liters.

### DETAILED DESCRIPTION

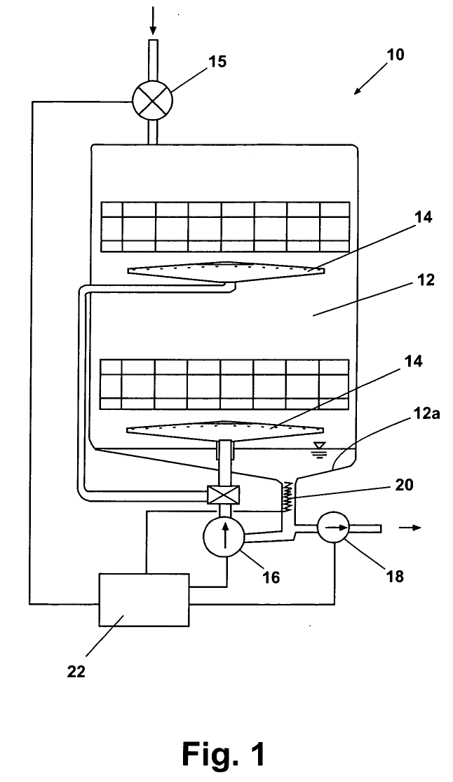

FIG. 1 depicts a dishwashing machine 10 having a washing chamber 12 defining a bottom wash water tank 12a and in which rotating spray arms 14 are rotatably mounted. Water is fed to the machine 10 through a flow meter 15 that gives information about the amount of water that has been loaded during the water inlet step. The spray arms are fed by a wash pump 16 that circulates water from the tank 12a to the spray arms 14. The machine 10 presents also a discharge pump 18 and a flow-through heating element 20. All the components of the dishwashing machine 10, and particularly the wash pump 16, the discharge pump 18, the heating element 20, the flow meter 15 and the user interface (not shown) are connected to an electronic control apparatus 22 which includes a microcomputer capable of storing control data. According to the invention, the control data stored in the control apparatus refer to power and current absorbed by a synchronous motor of the wash pump 16. The synchronous motor can be of every kind, but a 2-poles monophase synchronous motor, with a rotor having permanent magnets, is preferred. For programming the control apparatus 22 correctly, it is necessary to carry out specific tests on a dishwashing machine that will then be provided with the control unit according to the present invention.

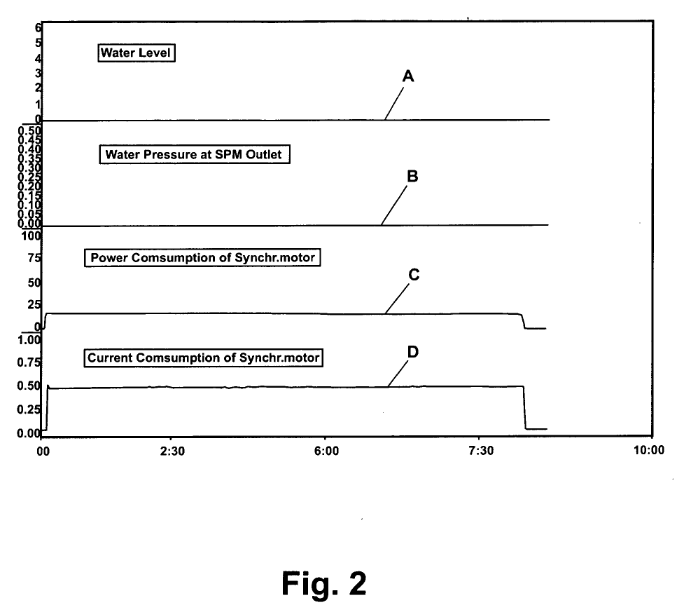

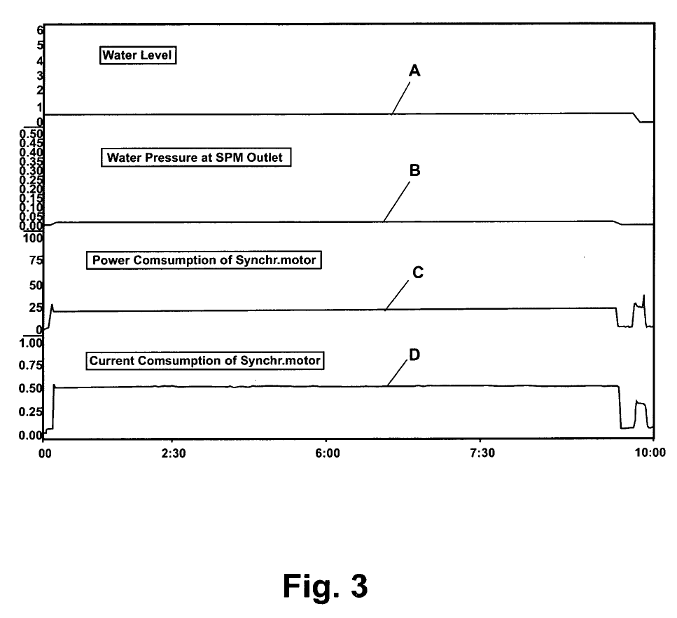

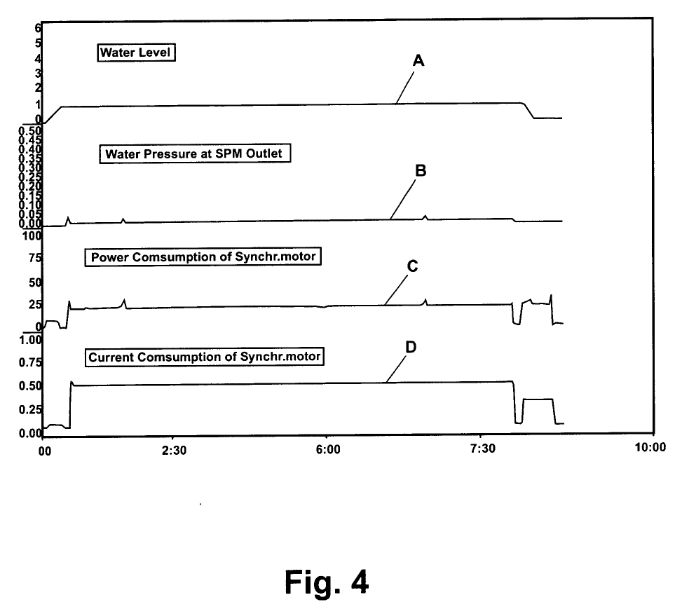

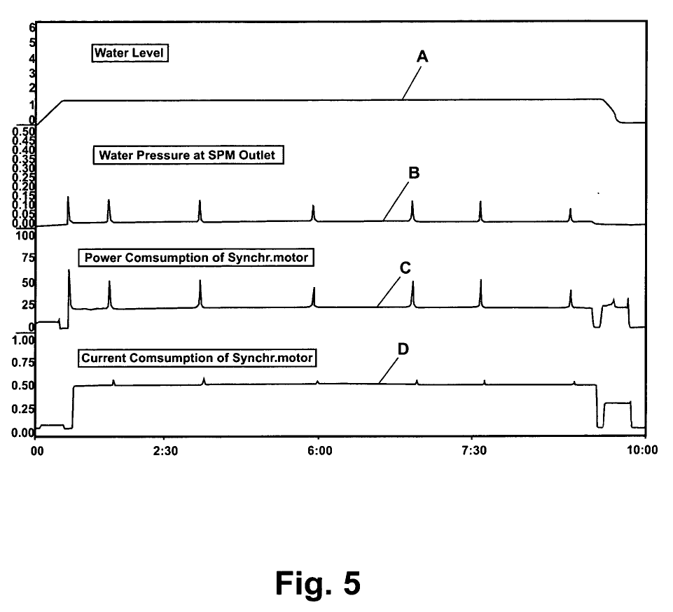

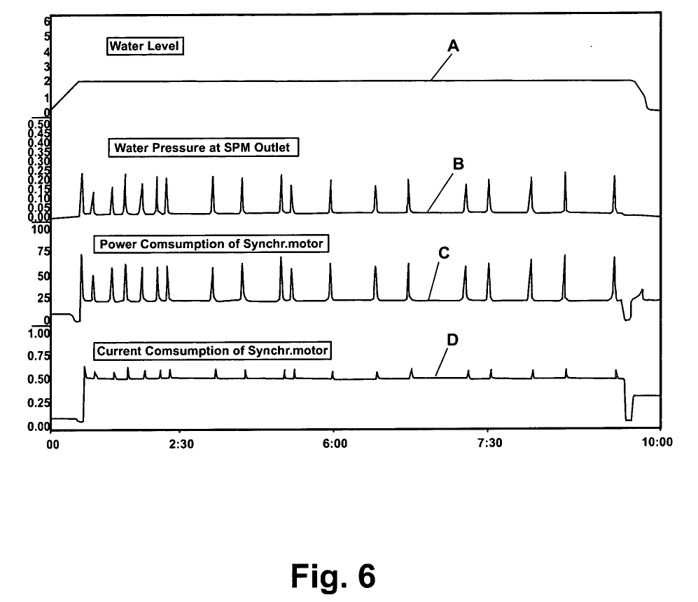

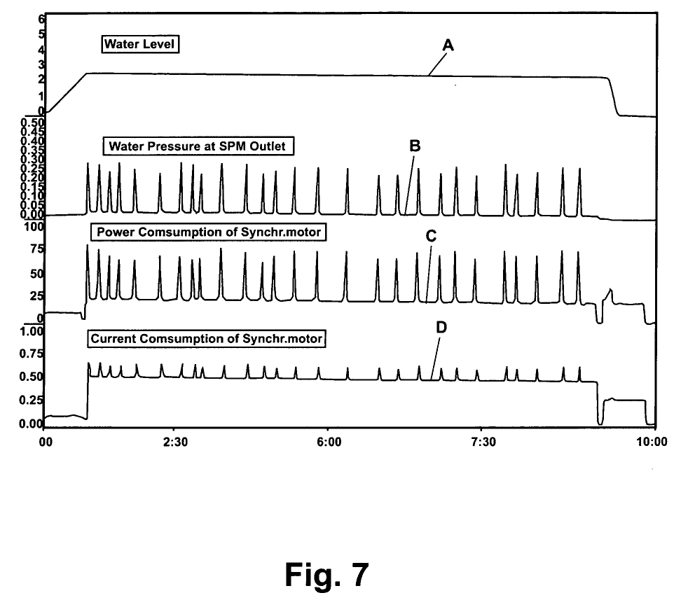

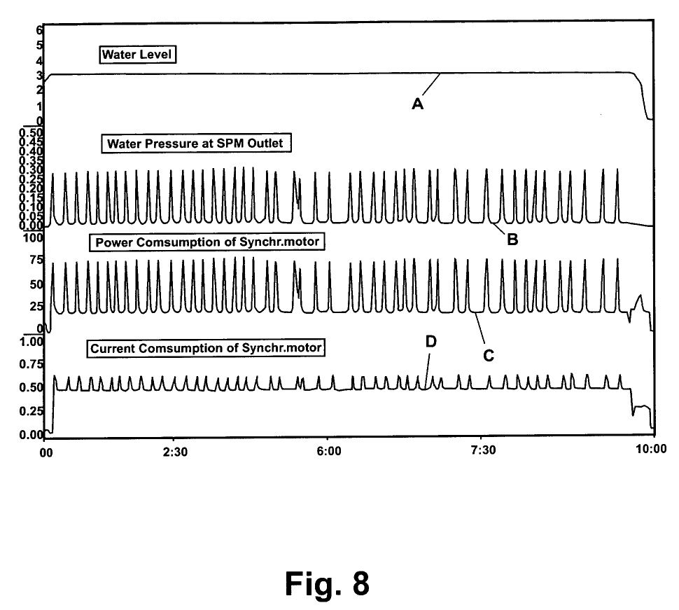

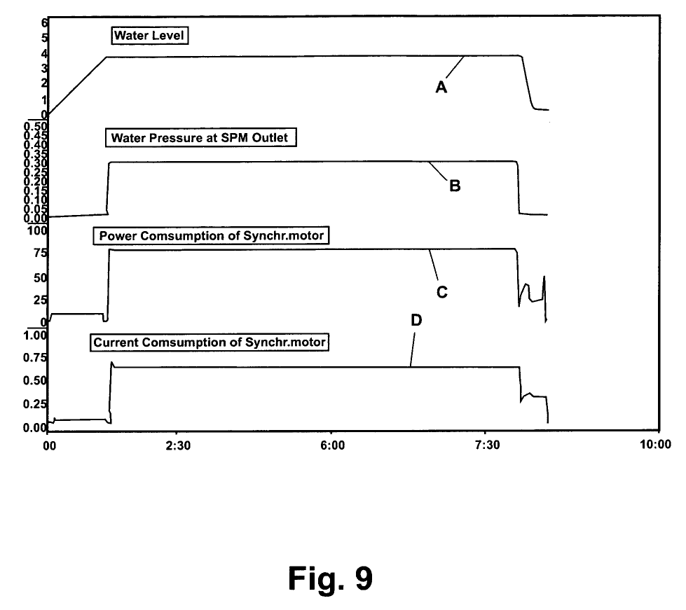

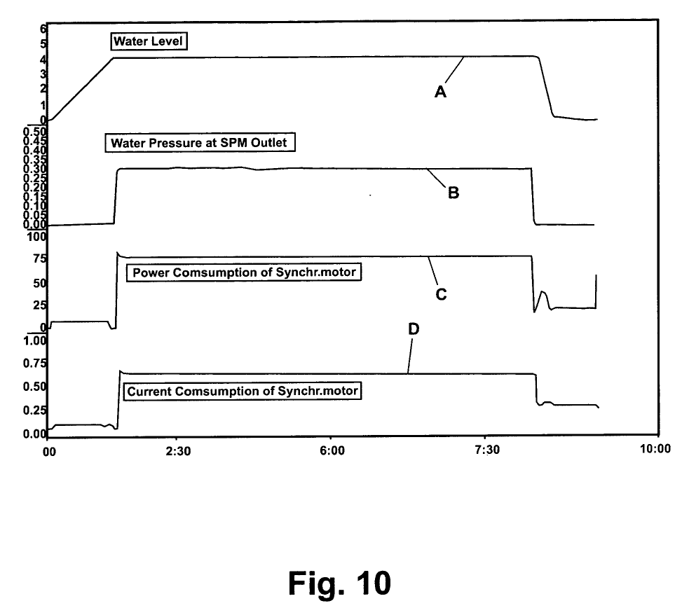

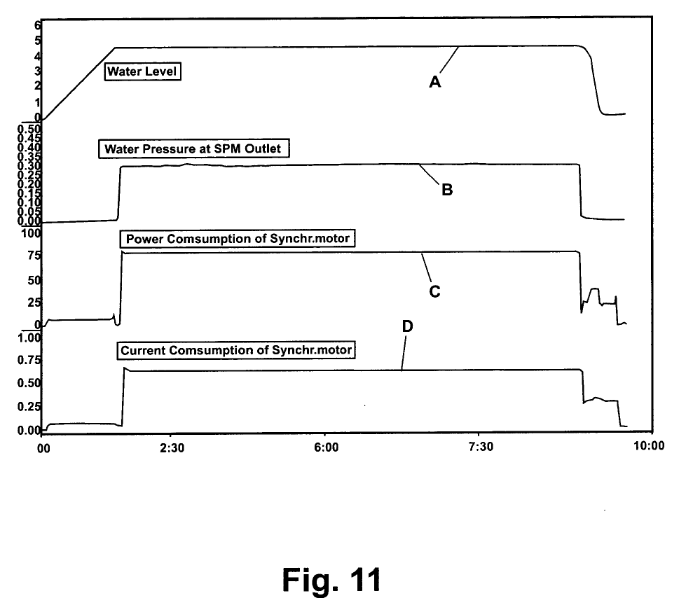

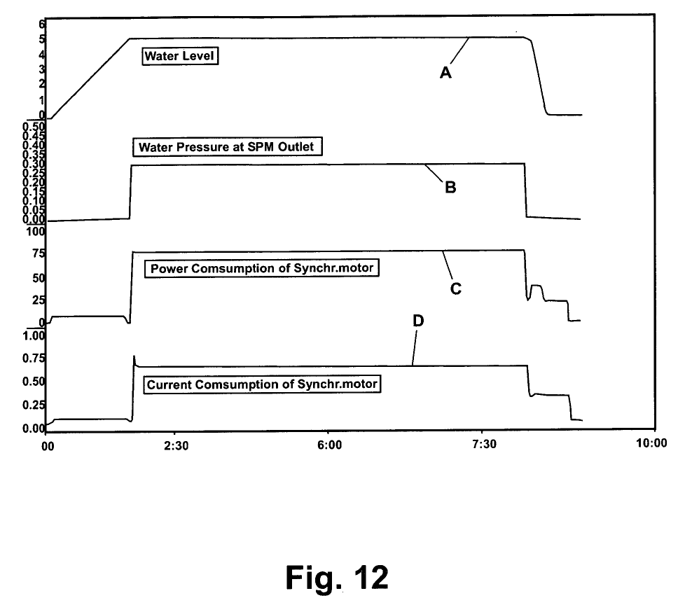

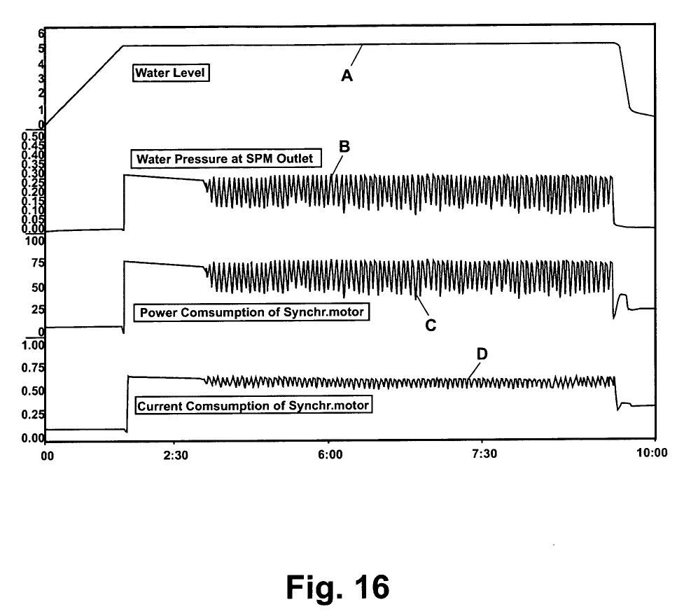

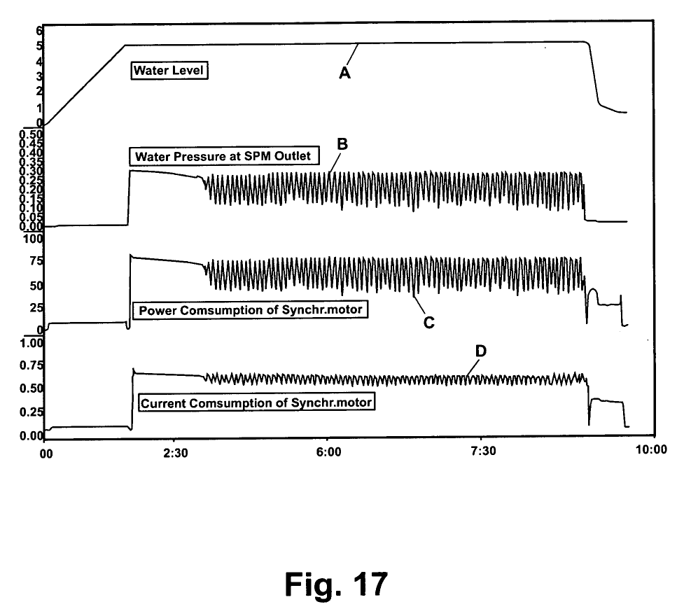

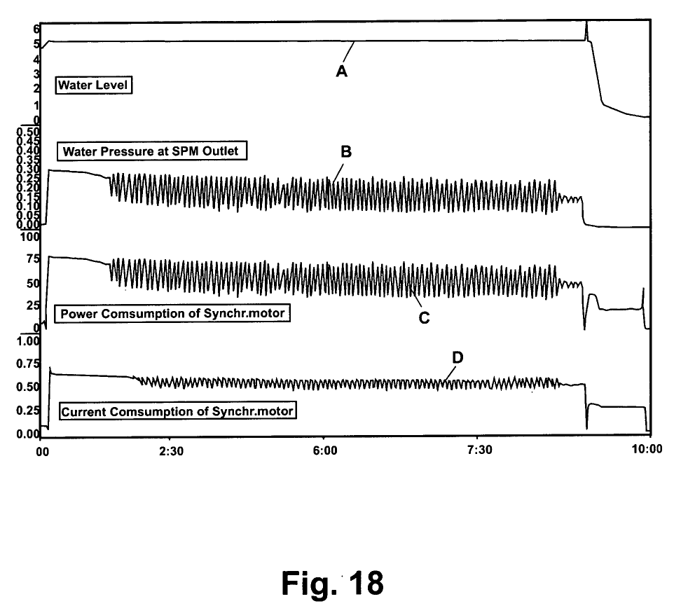

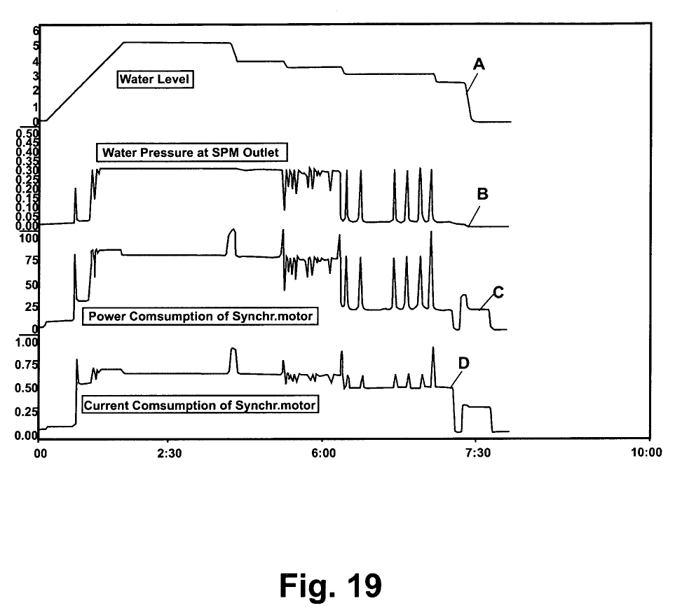

FIGS. 2-19 show an exemplary embodiment of how water level in the tank 12a, water pressure at the outlet of the wash pump 16, power consumption of the pump motor and current consumption of the pump motor change versus time in a dishwasher. The diagrams of FIGS. 2-19 contain all of the measurements that were recorded in conjunction with test execution.

The tests were performed on a dishwasher, where the circulating pump 16 has been provided with a synchronous motor in the 220/230V 50 Hz, 75 Watt, 3000 rpm version. The dishwasher was modified in such a way that the electronic control of the water supply, discharging pump 18 and circulating pump synchronous motor was replaced by a manual control system. In addition, a pressure connection was installed at the output of the circulating pump 16 for registering the pump pressure. To determine the intake volume in each case, the dishwasher was located on a Mettler IDS Multirange scale during execution of the tests. The following parameters were fed to a computerized data collection system DasyLab 7.00.03 via a serial port:
voltage, current and power data of the synchronous motor;
water pressure at the output of the circulating pump motor;
quantity of water.

The electronic traditional control unit of the dishwasher was deactivated and the operating conditions necessary for conducting the tests were implemented by manual control of the inlet valve, discharging pump and circulating pump.

The surprising result of the above investigation was that it is possible to avoid using a separate component utilized in present day series production to detect if there is water or not in the tank 12a of the dishwasher. This component is usually a membrane switch, which is installed directly in the tank and delivers an on-off signal to the electronic controller depending on the presence of water in the machine.

According to the investigation made by the applicant, water presence and wash process control are possible by measuring the current and/or power of the circulating pump synchronous motor in various operating states.

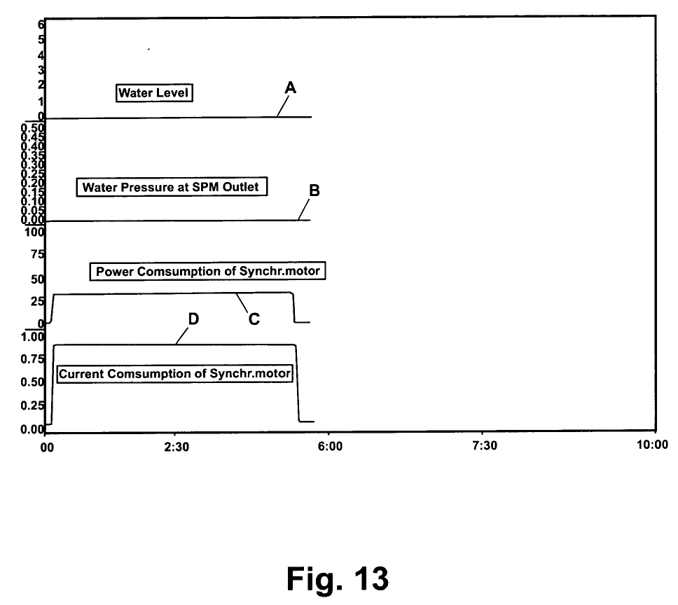

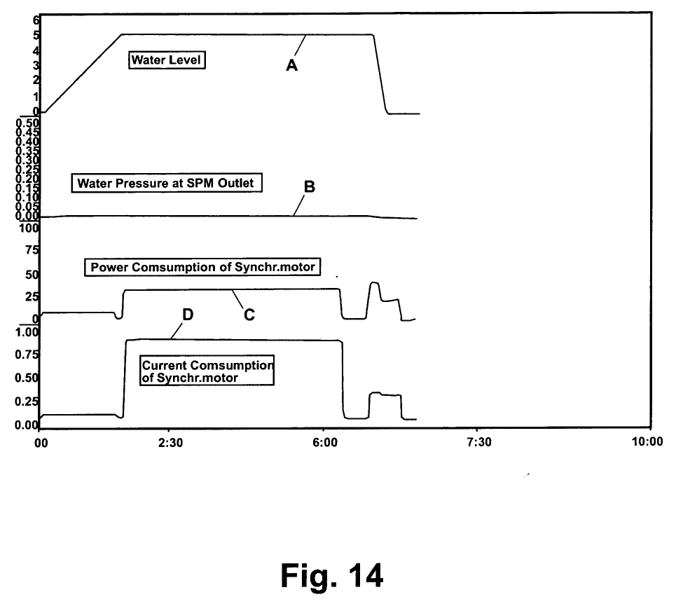

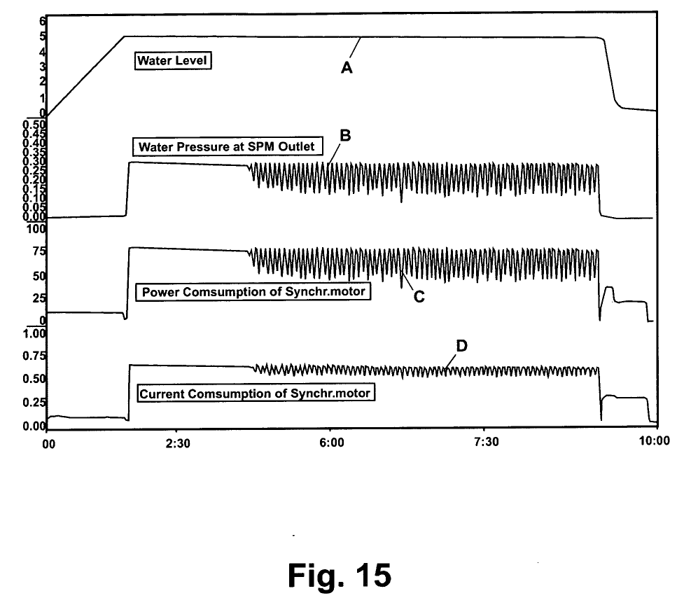

Through manual control of input of the discharge and circulating pumps, various operating states of a dishwasher were realized. Measurement of the current and power of the synchronous circulating pump motor was carried out in the following operating states:
Water volume [liters]: 0 (empty tank); 0.5; 1; 1.5; 2; 2.5; 3; 3.5; 4; 4.5; 5. The results of these tests are shown in FIGS. 2 to 12.
Circulating pump motor blocked with water volume of 0 liters and 5 liters. Results shown in FIGS. 13 to 14.
Water volume 5 and addition of a quantity of rinsing agent of [ml]: 0.5; 1; 2; 3. This simulates unstable operation of the circulating pump (foam, severe soiling). Results shown in FIGS. 15 to 18.

After the particular operating state was reached, an operating voltage was applied manually to the synchronous motor for a maximum period of 10 minutes, and the water volume, pump pressure and power and current consumption of the synchronous motor were measured while the motor was activated.

The measurement records, as shown in FIGS. 2-19, illustrate different signal levels and shapes of the motor current for low and high volumes of water. Thus water level recognition can be characterized by the level and shape of the motor current and/or motor power. Furthermore, the measurement records show that in addition both unstable operation and blockage of the circulating pump can be recognized through measuring the current of the synchronous motor. That makes it possible to realize control of the wash process such that in the case of unstable operation of the circulating pump caused by large quantities of foam and soil, additional water can be supplied until stable operation is again achieved. Even if by measuring the current of the synchronous motor it is not possible to detect in detail different levels of water in the dishwasher, nevertheless it is possible to detect clearly the following conditions:
(a) water inside the dishwasher. The synchronous motor is working under “full load” condition. This can only happen, if there is water inside the pump (no air). This condition corresponds to a predetermined current level and this means that water is certainly inside the dishwasher. Consequently the load of water into the machine was successful;
(b) no water inside the dishwasher. As a reversal of the previous condition (a) it is possible to detect if the synchronous motor is working under “no load” condition. This can only happen if there is air (i.e. no water) inside the pump. This condition corresponds to another predetermined current level. This means that there is no water or very less water inside the appliance;
(c) unstable run. The synchronous motor is working in a condition between “full load” and “half load”. This can only happen if there is a low amount of water inside the dishwasher or if there is a high amount of foam inside the tub. This condition causes a high frequent change between two different current levels. This means that there is not enough water inside the system and an additional water inlet (until the system detects again a stable run by “full load” working of the pump) is loaded through the software.

Of course all the above three different conditions correspond to predetermined amounts of water or water levels. For conditions (b) and (c) (no water/unstable run) the motor is not working in its operating point. Therefore the power/current consumption is different from condition (a) (water inside).

If the motor current is applied via a resistance connection as an analog voltage signal at the input of the microcontroller of an electronic dishwasher controller, appropriate evaluation by the software makes it possible to recognize whether:
there is a low or high volume of water in the wash water tank;
the circulating pump is in an unstable range (wash process control);
the circulating pump is blocked.

The measurement records show the power and current consumption of the circulating pump synchronous motor for various water levels and operating conditions, which were recorded by the applicant on the above mentioned specific dishwasher. To observe and assess the stability of the circulating pump, the pump pressure was also measured at the output of the synchronous motor.

From the data shown in FIGS. 2-19, it is possible to infer what is one way of programming the microcomputer of the control unit 22 to be used in the “tested” machine. The measurement results show that it is possible to detect if there's a water level corresponding to an amount higher than 3 liter inside the dishwasher or if there is a water level corresponding to an amount lower than 1.5 liter inside the dishwasher. Moreover we are able to detect unstable run (1.5<water-level<3 liter) caused by foam or too low water amount.

It is clear to a man skilled in the art that from the above experimental data (for each single specific model of dishwasher), it is possible to design easily an electronic control unit 22 that, starting from simple electric data of the pump motor, can assess different working condition of the machine. Such design can make use of look up tables, fuzzy logic or different algorithms.

1. A dishwashing machine, comprising:
a washing chamber;
a wash pump arranged to be driven by an electric motor for pumping up wash water from a wash water tank in the washing chamber; and
a control unit for controlling a washing cycle of the machine, wherein the control unit comprises means for detecting at least one working parameter of the electric motor, such parameter being linked to one or more parameters of the washing cycle.

2. The dishwashing machine of claim 1, wherein the electric motor of the pump is a synchronous motor.

3. The dishwashing machine of claim 1, wherein the working parameter of the electric motor is the absorbed power and/or the absorbed current.

4. The dishwashing machine of claim 2, wherein the synchronous motor is a 2-poles monophase motor.

5. The dishwashing machine of claim 3, wherein the motor current is applied via a resistance connection as an analog voltage signal at the input of the control system.

6. The dishwashing machine of claim 1, wherein the parameter of the washing cycle is the presence or absence of water in the wash water tank and/or the condition of the wash pump (stable/unstable, unblocked/blocked).

7. A method for controlling a dishwashing machine, comprising:
a washing chamber;
a wash pump arranged to be driven by an electric motor for pumping up wash water from a wash water tank in the washing chamber; and
wherein at least one working parameter of the electric motor is used as an input of a control unit.

8. The method of claim 7, wherein the electric motor of the pump is a synchronous motor.

9. The method of claim 7, wherein the working parameter of the electric motor is the absorbed power and/or the absorbed current.

10. The method of claim 7, wherein the working parameter of the electric motor is linked to the presence or absence of water in the wash water tank and/or the condition of the wash pump (stable/unstable, unblocked/blocked).
